(19) United States
(12) Patent Application Publication
(10) Pub. No.: US 2022/0284257 A1
(43) Pub. Date: Sep. 8, 2022

(54) Storing and Retrieving Identification Tag Data Associated With an Asset

(71) Applicant: Brady Worldwide, Inc., Milwaukee, WI (US)

(72) Inventors: Adam T. Meaux, Milwaukee, WI (US); Timothy Migacz, Pewaukee, WI (US); Steve Caster, Eeklo (BE)

(21) Appl. No.: 17/637,530

(22) PCT Filed: Aug. 27, 2020
(86) PCT No.: PCT/US2020/048227

§ 371 Date: Feb. 23, 2022

Related U.S. Application Data
(60) Provisional application No. 62/894,166, filed on Aug. 30, 2019.

(51) Int. Cl. G06K 19/077; G06K 19/07; H04W 4/80

(52) U.S. Cl. CPC G06K 19/07758; G06K 19/0723; H04W 4/80; G06Q 10/20

(57) ABSTRACT

Systems and methods of the present invention provide for one or more server computers communicatively coupled to a network and configured to receive identification tag data from the identification tag using the identification tag reader, receive and store additional data relating to the identification tag data or an associated asset and received from a GUI, display the identification tag or additional data responsive to scanning the tag, and receiving from a GUI search parameters used to identify a tag or associated resource, once scanned.

### CROSS-REFERENCE TO RELATED APPLICATIONS

This application claims the benefit of U.S. Provisional Application No. 62/894,166 filed Aug. 30, 2019, which is incorporated by reference herein for all purposes.

### FIELD OF THE INVENTION

The present invention generally relates to the field of associating identification tags with assets (e.g., servers, cables, and bundles of cables within a data center), and using the identification tags, tag readers configured to access data encoded within the identification tags, and computing devices in communication with the tag readers to store and retrieve data about the assets.

### SUMMARY OF THE INVENTION

The present invention provides systems and methods comprising one or more identification tags, one or more identification tag readers, and one or more computing devices communicatively coupled to a network and configured to receive identification tag data from the identification tag using the identification tag reader, receive and store additional data relating to the identification tag data or an associated asset and received from a GUI, display the identification tag or additional data responsive to scanning the tag, and receiving from a GUI search parameters used to identify a tag or associated resource, once scanned.

The above features and advantages of the present invention will be better understood from the following detailed description taken in conjunction with the accompanying drawings.

### BRIEF DESCRIPTION OF THE DRAWINGS

FIG. 1A illustrates a first non-limiting example of multiple identification tags coupled to self-laminating labels or markers.

FIG. 1B illustrates a second non-limiting example of multiple identification tags coupled to self-laminating labels or markers.

FIG. 2A illustrates a non-limiting example of labels.

FIG. 2B illustrates a non-limiting example of a label configured to be attached to an asset.

FIG. 3A illustrates a first non-limiting example of an identification tag reader.

FIG. 3B illustrates a second non-limiting example of an identification tag reader, including one or more antennas, an embedded software, and an embedded database.

FIG. 4A illustrates a possible system for storing and retrieving identification tag data associated with an asset.

FIG. 4B illustrates a plurality of network assets that have each been labeled using an identification tag.

FIG. 5 is a flow diagram illustrating method steps for a possible embodiment of a method for storing and retrieving identification tag data associated with an asset.

FIG. 6 is a user interface illustrating a possible embodiment for storing and retrieving identification tag data associated with an asset.

FIG. 7 is a flow diagram illustrating method steps for a possible embodiment of a method for storing and retrieving identification tag data associated with an asset.

FIG. 8 is a user interface illustrating a possible embodiment for storing and retrieving identification tag data associated with an asset.

FIG. 9 is a flow diagram illustrating method steps for a possible embodiment of a method for storing and retrieving identification tag data associated with an asset.

FIG. 10 is a user interface illustrating a possible embodiment for storing and retrieving identification tag data associated with an asset.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Near Field Communication (NFC) and Radio Frequency Identification (RFID) are examples of technologies that use integrated circuits incorporated into identification tags to track assets. NFC and RFID readers determine the presence of an active or passive NFC and/or RFID (or other identifier) tag within the field of the reader, and are therefore used to locate and identify one or more identification tags affixed to assets (including, for example, data center network assets, inventory, employee id cards, etc.). A single reader may interrogate, read, identify and locate thousands of tags in seconds.

As a non-limiting example described herein, NFC and/or RFID technologies may also be used in combination with such identification tags to assist in the generation and reception of information describing attributes of assets within a data center, such as the servers, and the server cables and/or bundles of cables used within a network accessible by a data center. A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

A well-known example of a network is the Internet, which is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as websites. The combination of all the websites and their corresponding web pages on the Internet is generally known as the World Wide Web or simply the Web.

Within a data center, the servers and/or other computers may be networked together using any network cables known in the art to interconnect or power all of the components within the data center. Non-limiting examples of such cables include fiber optic cables, Ethernet cables, fiber channel cables, copper cables, AC/DC power cables, ground cables, etc. As the data center grows, more and more servers and other networking components (switches, routers, etc.) may be installed, and each of these networking components may be networked together and to external networks, such as the Internet and/or an Internet service provider, for example. Many times, the connection of these network resources is accomplished using network cables, such as fiber optic cables, Ethernet cables, etc. Likewise, a great deal of power is required to power the networking components, the data center itself, and cooling for the data center, requiring the data center to have multiple power and/or ground cables, as non-limiting examples.

As the number of networking components in the data center grows, the number of network, power, and other associated cables required may likewise grow proportionally, sometimes including thousands of cables. Like any resources, over time, these network and power cables may break down. When this happens, the enormous number of cables may make it difficult to identify a specific cable or server, or even a bundle of cables associated with the server, in order to repair or replace the problem cable.

To simplify the task of identifying a specific asset, the disclosed embodiments allow users to attach or otherwise associate a first (e.g., short-range) identification tag (e.g., NFC) and/or a second (e.g., long-range) identification tag (e.g., RFID) to each of the assets or collections of assets. For example, users in the disclosed embodiments may attach an identification tag to each of a particular server, cable, and/or bundle of cables.

The users of the disclosed embodiment may then use an identification tag reader to scan each tag in order to retrieve the data stored on the tag, such as a unique identifier encoded into the tag, and transmit the scanned data through a network to a computing device, such as a server or client device.

In some embodiments, the identification tag reader may have an embedded software and/or database. In these embodiments, the scanned data from the tag may be processed by the software and stored in the embedded database. The data may then be transmitted through the network to the computing device, which may receive the scanned data, process it, generate a database record associated with the tag, and store it in the system database. In some embodiments, the data record may be identified by the unique identifier encoded into the tag. In some embodiments, the reader may read the data stored in the tag, and stream the data through the network to the computing device, which may receive the scanned data, process it, generate the database record associated with the tag (possibly identified using the encoded unique identifier), and store it in the system database. Additional embodiments may be envisioned in which the data stored on the tag is read and processed using security, which would require some type of encryption as the data is passed from the tag to the reader to the server to the client, etc.

The computing device may then generate a graphical user interface (GUI) on a display screen of the computing device with one or more GUI components allowing a user to input additional details associated with the tag or the asset to which the tag is attached or near, such as a name, an associated resource, the purpose of the resource, user comments about the tag, etc. In embodiments that use a long-range identification tag (e.g., RFID), the GUI may include a GUI component (e.g., a checkbox) specifying that the asset is best identified using a particular identification tag protocol to locate the asset. In embodiments including multiple computing devices, a server device may transmit the GUI to a client device for display.

Using the generated and displayed GUI, the computing device may receive user input, including additional input by the user in association with the tag data, such as additional descriptors, images, or data, for example. In embodiments that use a long-range identification tag and in which the appropriate GUI component is selected (e.g., a checkbox checked), the data record may be updated to include a flag that the reader should scan using a long-range identification tag protocol, such RFID. In embodiments including multiple computing devices, the client device may then transmit the received user input data to the server device. The computing device may then receive the input data, and store the updated data in the appropriate data record in association with the tag identifier.

Once the database is populated with all of the asset data (and the asset data is associated in the database with particular tag identifiers), users may use the identification tag reader to scan any of the individual tags associated with the assets. In embodiments in which the reader includes an embedded software and database, the reader may temporarily upload the database records into the embedded database. The reader may receive the tag data from each tag as it is scanned. In embodiments where the reader includes an embedded software and database, the embedded software in the tag reader may receive and process the scanned tag data from each tag, and execute a database query selecting a data record from the embedded database that has a common unique identifier. The embedded software on the reader may then transmit the data from the matching data record to the computing device for processing. In embodiments where the reader streams the scanned tag data through the network to the computing device, the computing device may receive and process the scanned tag data from each tag, and execute a database query selecting a data record from the database that has a common unique identifier.

The computing device may then generate a GUI for displaying the data stored in the matching data record, and display this GUI to the user. In embodiments including multiple computing devices, a server device may generate aspects of the GUI, and transmit the GUI through the network to a client device for display.

In some embodiments, a user may want to search for an asset associated with a specific identification tag (e.g., find the identification tag for a network cable that a data center system determines is malfunctioning, so that it may be replaced). In these embodiments, the user may access the system and indicate a desire to locate one or more assets associated with one or more specific identification tags. In response to this request, the computing device may generate a GUI receiving input from the user defining the search parameters for finding the assets and their associated identification tags.

For example, for each identification tag the user wants to locate, the GUI may include one or more GUI components for receiving user input from the user including the identification tag's unique identifier, the asset associated with the identification tag, a name of the asset, the purpose of the asset, notes input by the user, etc. In embodiments that use a long range identification tag (e.g., RFID) to identify an associated asset (e.g., the server or network cable bundle associated with the cable they are trying to find), the system may identify the flag indicating that the long range identification tag protocol should be used first to locate the first asset (e.g., the server or network cable bundle), and then apply the short range identification tag protocol (e.g., NFC) to locate the specific cable.

In embodiments including multiple computing devices, a server device may generate the GUI, and transmit the GUI through the network to a client device for display. Once the GUI is displayed, the user device (e.g., a client device) may receive the user input and transmit it through the network to the server device for processing. This processing may include using the input from the GUI to identify data records in the database that include data matching that input by the user into the GUI. The computing device may then select the matching data record(s) from the database, possibly using database query commands. The selected data may include the unique identifier for a tag stored in the data record, and possibly related asset data, as received above.

In embodiments where the reader includes an embedded software and database, the computing device may transmit the selected data from the database (the selected identification tags and their associated asset data) through the network to the reader for processing by the embedded software and storage in the embedded database. In embodiments where the reader streams the scanned tag data through the network to the computing device, the computing device may temporarily store the selected data from the database on the computing device. The user may then scan for the requested identification tag and its associated asset.

In embodiments that use a long range identification tag to identify an associated asset (e.g., the server or network cable bundle associated with the cable they are trying to find), the selected data may include the database flag indicating that the reader should scan using a long range identification tag protocol, such as RFID. In embodiments where the reader includes an embedded software and database, the computing device may transmit the flag through the network to the reader, which may process the flag and automatically use the long-range identification tag protocol to scan the identification tags. In embodiments where the reader streams the scanned tag data through the network to the computing device, the computing device may use the data flag to indicate that the reader should be utilizing the long-range identification tag protocol to scan the tags.

As the user scans for the requested identification tag, the reader may receive the data from each of the identification tags, and compare the received data with the data stored in the embedded database using the embedded software, or transmitted through the network to the computing device and compared with the temporarily stored selected data on the computing device.

The reader may further include optical (e.g., light emitting diode (LED)) or audio components integrated into the reader providing for audio and visual notifications (e.g., audio alerts or LED signals), configured by a user, so that when the scanned and received identification tag data matches a unique identifier stored in the embedded database (for embodiments that include an embedded software and/or database), or a unique identifier temporarily stored on the computing device (for embodiments where the reader streams the scanned tag data through the network to the computing device) the device may trigger an illumination of a custom color LED, and/or a custom audio alert. The user may then identify the long-range identification tag associated with the asset (e.g., the server or network cable bundle to which the desired cable belongs).

In some embodiments, the identified match may be received by the computing device, either from software logic on the computing device, or through the network from the embedded software on the reader. In response to receiving the identified match, the computing device may generate a GUI, or a command to update a currently displayed GUI, which displays a GUI component with a notification indicating that the most recently scanned identification tag/asset matches one of the unique identifiers selected from the database records. This notification may then be displayed on the GUI on the computing device.

In embodiments that use a long-range identification tag to identify an associated asset, the embedded software may include logic to automatically switch from a long-range identification tag protocol, to a short-range identification tag protocol, for embodiments that include an embedded software and/or database. For embodiments where the reader streams the scanned tag data through the network to the computing device, the computing device, subsequent to transmitting a signal triggering the custom alert on the reader, may include logic to switch from a long range identifier protocol to a short range identification tag protocol.

Once the reader is operating using the short range identification tag protocol (e.g., NFC), or in embodiments that that use a short range identification tag to identify an associated asset (e.g., the individual cable that the user is trying to find associated with the identified server or network cable bundle), The user may then scan for the requested identification tag and its associated asset.

In embodiments where the reader includes an embedded software and database, if there is no flag indicating the use of long range identification tag protocol, or if the reader has switched from a long range to a short range identification tag protocol subsequent to finding a matching identification tag using long range identification tag protocol, the reader, in association with the computing device, may automatically use the short range identification tag protocol to scan the identification tags. In embodiments where the reader streams the scanned tag data through the network to the computing device, the computing device may fail to identify a flag indicating the use of long-range identification tag protocol, or data logic that now indicates that the reader should be utilizing the short-range identification tag protocol to scan the tags.

As before, as the user scans for the requested identification tag, the reader may receive the data from each of the identification tags, and compare the received data with the data stored in the embedded database using the embedded software, or transmitted through the network to the computing device and compared with the temporarily stored selected data. The reader may include components integrated into the reader providing for audio and visual notifications (e.g., audio alerts or LED signals), configured by a user, so that when the scanned and received identification tag data matches a unique identifier stored in the embedded database (for embodiments that include an embedded software and/or database), or a unique identifier temporarily stored on the computing device (for embodiments where the reader streams the scanned tag data through the network to the computing device) the device triggers illumination of a custom color LED, and/or a custom audio alert. The user may then identify the short-range identification tag associated with the asset (e.g., the cable connected to the server or included within the network cable bundle).

In some embodiments, the identified match may be received by the computing device, either from software logic on the computing device, or through the network from the embedded software on the reader. In response to receiving the identified match, the computing device may generate a GUI, or a command to update a currently displayed GUI, including a GUI component including a notification indicating that the most recently scanned identification tag/asset matches one of the unique identifiers selected from the database records. This notification may then be displayed on the GUI on the computing device.

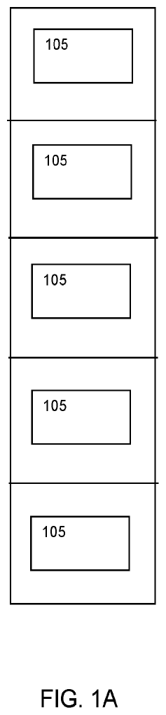

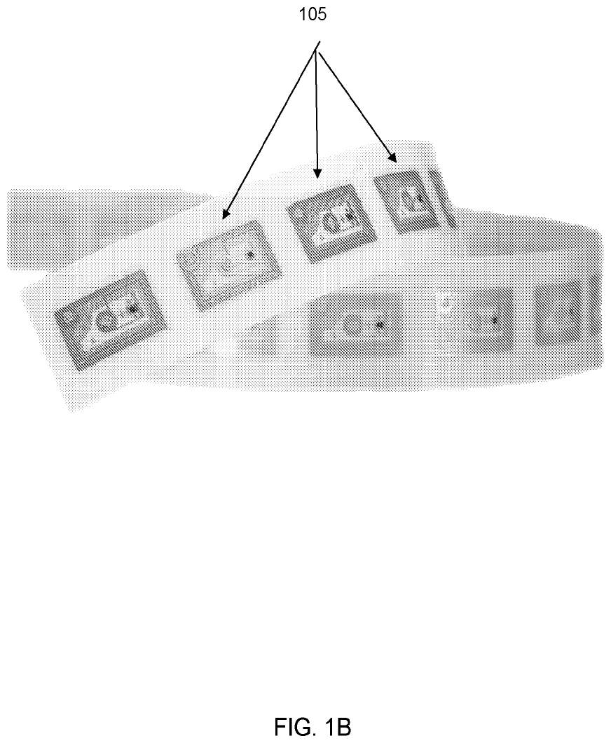

Several different environments may be used to accomplish the method steps of embodiments disclosed herein. As seen in FIGS. 1A and 1B, the disclosed embodiments may utilize one or more identification tags 105, possibly including one or more short-range identification tags and/or one or more long-range identification tags mounted or embedded within an adhesive backing. As non-limiting examples, the short range identification tags may include one or more wireless NFC tags, and the long range identification tags may include one or more wireless RFID tags, both of which may further comprise a microchip utilizing user memory (each of which may include a unique identifier) and possibly coupled to labels, possibly embedded within, upon the surface or, or otherwise affixed or attached to the labels.

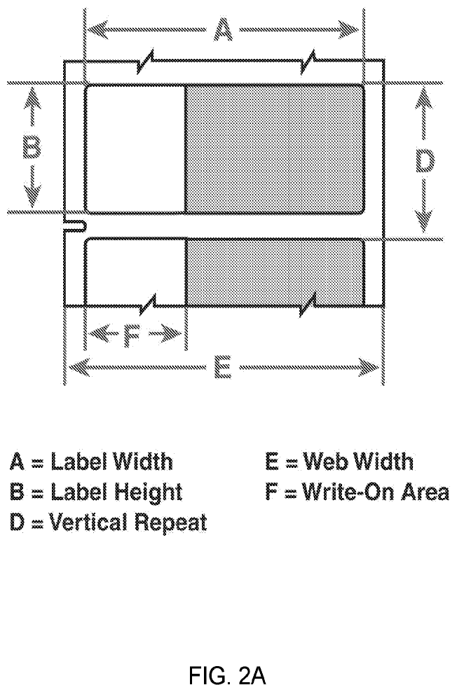

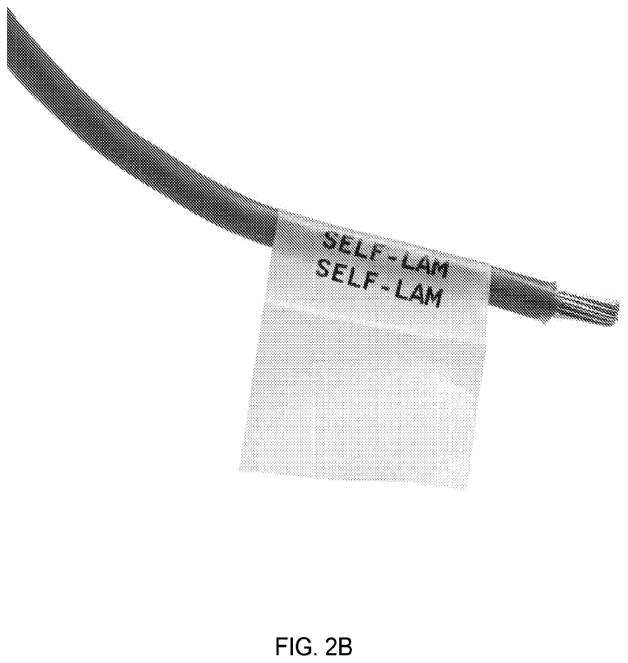

FIGS. 2A and 2B demonstrate non-limiting examples of labels that may be used in the disclosed embodiments. In some non-limiting example embodiments, such as that seen in FIG. 2A, these labels may comprise a rectangular body generally comprising three layers, including a substrate, an adhesive, and a removable liner. In some embodiments, to use the label, a user may remove a release liner from the label and expose the adhesive on the lower surface of the substrate. In some embodiments, the substrate of the label may be wrapped around itself until there is no more substrate left.

In some embodiments, the labels may include self-laminating markers. In some embodiments, the label may include a printable area on which a user may include a label, a clear film layer, and a tail end. In some embodiments, the label or marker may be provided as part of a media roll or strip, with individual labels or markers being separated from the roll or strip, as are seen in FIGS. 1A and 1B.

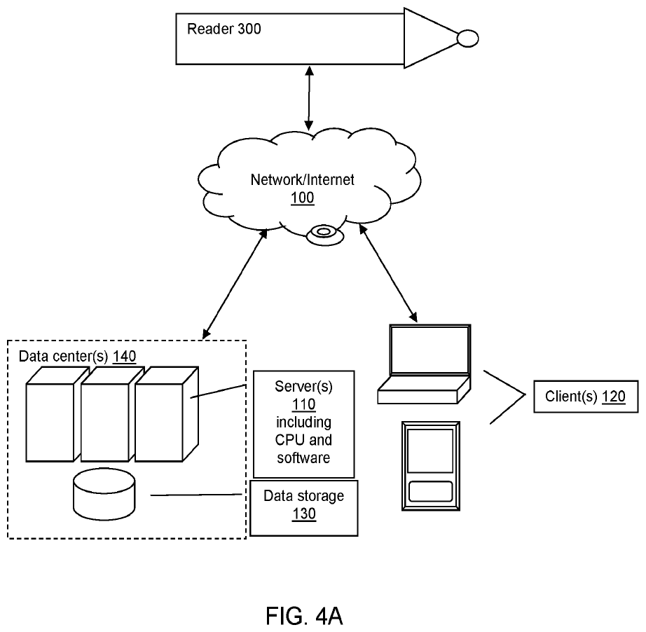

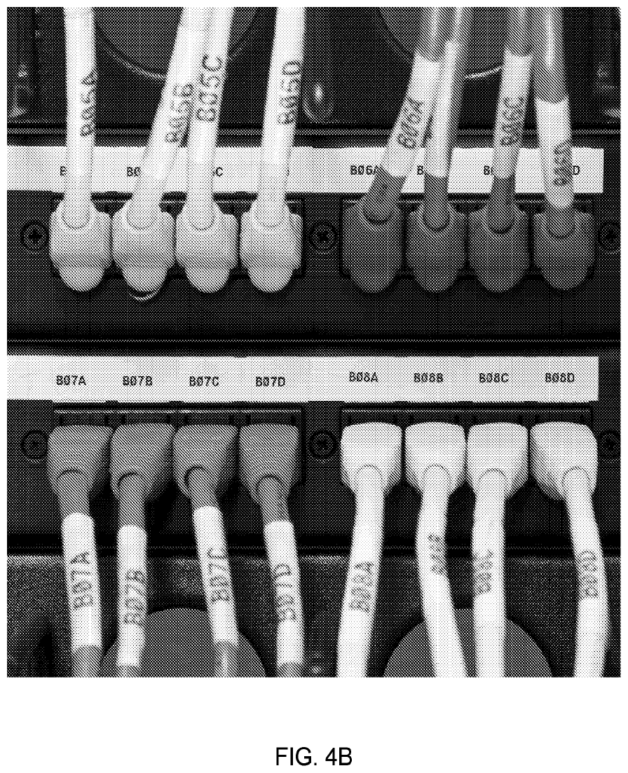

In some of the disclosed embodiments, such as that seen in FIGS. 2B and 4B, the label may comprise a wire marker, comprising a label or tag that is attached to a wire or cable for purposes of identifying it and/or its purpose.

Non-limiting examples of such self-laminating labels with embedded long-range or short-range identification tags 105 are demonstrated in FIGS. 1A-2B. However, these examples are non-limiting. The identification tags 105 in the disclosed embodiments may include tags configured to be utilized in combination with any wireless interrogation technologies (e.g., which may include any so-called short range or long range identification tag technologies) known in the art wherein the tags may be configured to be attached to assets and read by an identification tag reader 300.

The tags 105 in the disclosed embodiments may utilize a wireless transmission broadcast, which may be read by an identification tag reader 300 in response to an interrogation signal transmitted by the identification tag reader 300. Thus, the tags 105 in the disclosed embodiments may be utilized to automatically identify and track the location and/or status of assets in real time, possibly within a building or other contained area, such as the data center(s) 140 described herein. As non-limiting examples, assets may include people or objects, such as the network components described in more detail below (e.g., a server 110, a server cable, a grouping or bundle of server cables, etc.), inventory items, people's identification tags, etc.

These tags 105 may use any combination of passive or active short-range or long-range identification tag technology. Active identification tag technology utilizes battery-powered beacons that continuously emit a signal, including a unique identifier for each tag 105. Passive identification tag technology uses no batteries, harvesting energy from a tag reader unit 300 (described below) to power and transmit a wireless transmission broadcast of its unique identifier and any additional data on the tag 105 to the reader 300, in response to an interrogation signal broadcast by the reader 300. In some disclosed embodiments, only passive tags are used.

Thus, by attaching the label containing the identification tag 105 to each asset within the disclosed system, the asset may be assigned a unique identification tag 105. The identification tag 105 may be registered within software or a database as being associated with the asset, as described below. Each reader 300 may generate an alert, or notify the one or more servers 110 and/or clients 120 when a passive or active tag 105 enters and leaves the reader's 300 field.

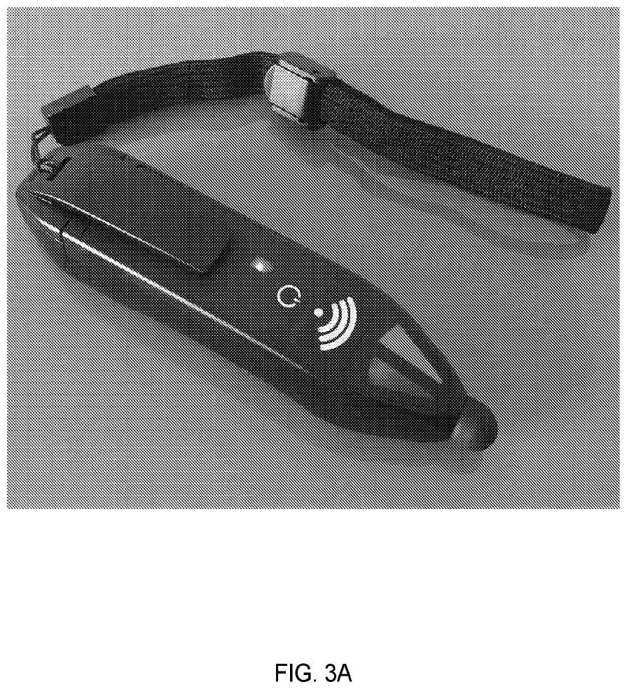

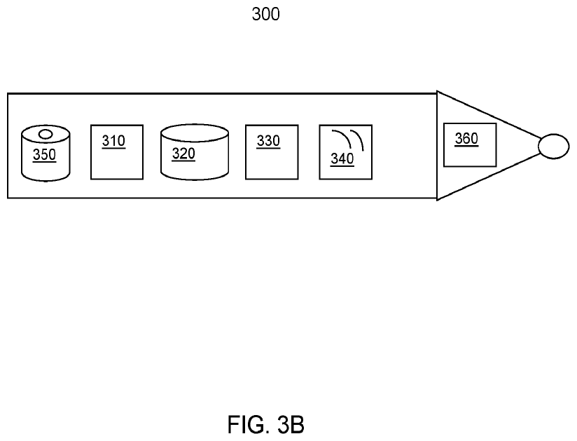

FIGS. 3A and 3B demonstrate an example identification tag reader unit 300. Each reader 300 may be self-contained, including one or more fixed-position or mobile passive and/or active EPC Gen 2 (and ISO 18000-63) compliant short-range or long-range identification tag reader/writer configurations. Each reader 300 may be a standalone device, or may be one of several devices within the designated location, as part of an integrated system used to track and locate tagged assets according to the proximity of tags 105 to the nearest reader 300.

Each reader 300 may be configured to transmit an interrogation signal configured to detect the presence through a wireless transmission broadcasts of one or more tags 105 (and by extension its associated asset) within the reader's 300 field of view in order to track their presence. This detection may be responsive and/or according to each tag's 105 wireless signal and Received Signal Strength Indicator (RSSI) relative to the fixed reference point of the reader 300. The reader 300 may further optionally determine the location of each tag 105 within its field of view. As non-limiting examples, the reader 300 may be able to track networking components within a data center 140, automobiles through an assembly line, locate pallets of merchandise in a warehouse, find equipment or employees within an office building, etc.

The reader 300 may further receive input from the tag 105 in the form of a unique identification for the tag 105, the RSSI for signal received from the tag 105, and/or any additional data stored on the tag 105. In some embodiments, the readers 300 may be configured for sensory data aggregation. For example, each reader 300 may have sensors that identify, in association with each unique tag id, temperatures associated with each unique tag id; extensive motion, such as would be experienced during an earthquake; etc.

The tag data received by a reader 300 may be analyzed and processed using onboard firmware or other software 310, and/or may be communicated (e.g., through a local network) to a proprietary software running on a dedicated server 110 or client 120, which processes the received data. This processed data may be used for asset identification, asset tracking, inventory and management in data center 140, retail, and/or supply-chain or logistics environments, for example.

Identification tag reader technology may allow each reader 300, combined with each reader's 300 configuration to run programmable logic, to operate in a bi-directional, cloud-based environment, as seen in FIG. 4A, and may further allow for bi-directional two way communication between the reader device 300 and an application server 110 and/or a client device 120. For example, as described below, each reader 300 may include an embedded software 310 and/or database 320, installed and running within the reader 300 itself, and configured to communicate meaningful information both within and from the reader 300.

This remote deployment and two-way communication between the reader device 300 and the server 110 and/or client 120 device allows the server 110 and/or client 120 device to administer, deploy, and install customizable software 310 to be run on the device 300, which may be programmed to communicate meaningful information at the position of installation. This software 310 may support configurable program logic, profiles and/or parameters that may program the device 300 to determine hardware behavioral operation for common applications running on the device 300 (e.g., asset tracking).

Each of these devices may be embedded with electronics, software, sensors, actuators, and network connectivity, either among each of these components or with connected servers 110 and/or client devices 120, that enable the devices 300 and their embedded software 310 to collect and exchange data.

The programmable and configurable software logic described above may be configured to receive instructions to scan for one or more tags, possibly in response to receiving user input from a scan button 340 on the reader, or through configurable logic within the software 310. The reader 300 may then transmit an interrogation signal. The reader 300 may receive a wireless transmission broadcast from the identification tag 105, thereby receiving a notification that a tag 105 has entered the field of view for the reader 300 operating in a long-range and/or short-range reader configuration, and store related data within the internal database 320. The software 310 may process, within the reader 300 itself, the received tag 105 information to determine a current tag data for each detected tag 105, based on conditions met within the programmable and configurable logic. This messaging model also allows for messages to be sent, upon different events occurring in the system, to the server 110 and/or client 120 devices as a non-limiting example. Thus, in some embodiments, the reader 300 may be a reader capable of being programmed to perform customized independent actions, and to both communicate with, and receive communications from, additional devices.

For example, each reader 300 may download and install the customizable software 310, as well as the programmable logic, profiles, and/or parameters from a central location (e.g., from an application server 110). As a tag 105 associated with a specific asset or person enters the reader's 300 field (possibly in response to user input using the scan button 340), the reader 300 may detect the presence of the tag 105, and store the tag within the reader's 300 internal database 320. The programmable logic, profiles, and/or parameters within the customized and configurable software 310 may cause the reader 300 to respond conditionally to the identified tag 105.

In one non-limiting example embodiment, a host server 110 may push the customizable software 310, as well as the programmable logic, profiles, and/or parameters, to one or more readers 300, which may efficiently process and communicate tag state data for each tag 105 within the reader's 300 field of view.

In some embodiments, the short range or long range identification tag readers 300 may include models that do not process the received tag data, but instead, merely read the data from all tags 105 within the reader's 300 field at a given point in time, and stream the data from all identified tags 105 (as many as hundreds a second), through the local network 100 for processing by the customizable software running on the server 110 and/or client 120. Server-based rule engines may then process the tag data collected by the reader 300. As noted above, the network 100 may be a wired network or cloud-based networks accessible via Wi-Fi and/or Bluetooth.

Thus, readers 300 may either include embedded programmable firmware (e.g., onboard software 310 and database 320) which identifies all readable tags and responds accordingly, or a read-only reader, which receives information about the assets and transmits the data to one or more servers 110 and/or client devices 120 for processing, thereby providing for a low bandwidth, 2-way, cloud enabled communication between the reader 300 and the computing device 120 for purposes of asset identification, location, and tracking.

The identification tag reader 300 may further include one or more internal antenna 330 as part of a communications subsystem (e.g., for connecting to a network, such as an Ethernet network, a fiber optic network, a Wi-Fi wireless network, a Bluetooth network, etc., and/or detecting the presence of an identification tag 105, as described above), and in light of the features above, may be a read/write unit. Each of the one or more antennas 330 may include antenna circuitry that wirelessly receives data from the identification tag(s) 105. In some embodiments, the one or more antennas 330 may include a short-range antenna circuit to wirelessly receive data from the identification tags 105 using an NFC protocol. In some embodiments, the one or more antennas may include a long-range antenna circuit to wirelessly receive data from the identification tags 105 using a Radio Frequency Identification protocol.

The identification tag reader 300 may further include an implemented touch tip, used as input for devices such as tablets and smartphones with touch and capacitive screens. It may include a Bluetooth interface, which may be configured to connect to and work together with, as non-limiting examples, Windows, Android, and iOS devices, for mobile data capture. It may further include a focused NFC/RFID antenna 330 as described above, main RF field direction, a scan button 340, an operation state LED 360, the touch tip described above, and so forth.

The reader 300 may further include hardware 360 for providing visual or audio feedback. The configurable logic, profiles and/or parameters may create audio and visual notifications integrated into the reader (e.g., audio alerts or LED signals), possibly configured by a user, so that when a specific tag 105 passes by the reader device 300, the reader device 300 triggers illumination of a custom color LED, and/or a custom audio alert 360.

The long range and/or short range identification tag reader 300 may be set up and configured with additional hardware (e.g., a power source or battery, for example) and software (e.g., customizable software specific to each deployment of labels, as described above, if needed), thereby making the results from the reader 300 accessible to the network 100, possibly using a network cable configuration, a wireless network, and/or Bluetooth technologies.

FIG. 4A demonstrates a streamlined example of an environment including a system and/or structure that may be used to accomplish the methods and embodiments disclosed and described herein. For example, FIG. 4A includes the data center 140 referenced above, which may host one or more servers 110 and/or other computers in the data center 140 as well as providing the general infrastructure necessary to offer hosting services to Internet users including hardware (e.g., server computing machines, routers, switches, network cables, power cables, etc.), software, Internet web sites, hosting servers, and electronic communication means necessary to connect multiple computers and/or servers to the Internet or any other network 100.

The example embodiments shown and described herein exist within the framework of a network 100 and should not limit possible network configuration or connectivity. Such a network 100 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

At least one server 110 and at least one client 120 may be communicatively coupled to the network 100 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The methods disclosed herein may be performed by any central processing unit (CPU) in any computing system, such as a microprocessor running on at least one server 110 and/or client 120, and executing instructions stored (perhaps as scripts and/or software, possibly as software modules/components) in computer-readable media accessible to the CPU, such as a hard disk drive on a server 110 and/or client 120.

Server(s) 110 may comprise any computer device or program that provides services to other computers, programs, or users either in the same computer or over a computer network 100. As non-limiting examples, the server 110 may comprise application, communication, mail, database, proxy, fax, file, media, web, peer-to-peer, standalone, software, or hardware servers (i.e., server computer devices) and may use any server format known in the art or developed in the future (possibly a shared hosting server, a virtual dedicated hosting server, a dedicated hosting server, a cloud hosting solution, a grid hosting solution, or any combination thereof) and may be used, for example to provide access to the data needed for the software combination requested by a client 120.

The server 110 may exist within a server cluster. These clusters may include a group of tightly coupled computers that work together so that in many respects they can be viewed as though they are a single computer. The components may be connected to each other through fast local area networks which may improve performance and/or availability over that provided by a single computer.

The server 110 and/or client 120 may be communicatively coupled to data storage 130 including any information requested or required by the system and/or described herein. The data storage 130 may be any computer components, devices, and/or recording media that may retain digital data used for computing for some interval of time. The storage may be capable of retaining stored content for any data required, on a single machine or in a cluster of computers over the network 100, in separate memory areas of the same machine such as different hard drives, or in separate partitions within the same hard drive, such as a database partition.

Non-limiting examples of the data storage 130 may include, but are not limited to, a Network Area Storage, (“NAS”), which may be a self-contained file level computer data storage connected to and supplying a computer network with file-based data storage services. The storage subsystem may also be a Storage Area Network (“SAN”— an architecture to attach remote computer storage devices to servers in such a way that the devices appear as locally attached), an NAS-SAN hybrid, any other means of central/shared storage now known or later developed or any combination thereof.

Structurally, the data storage 130 may comprise any collection of data. As non-limiting examples, the data storage 130 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

The server(s) 110 and/or client(s), or software modules within the server(s) 110 and/or client(s), may use query languages such as MSSQL or MySQL to retrieve the content from the data storage 130. Server-side scripting languages such as ASP, PHP, CGI/Perl, proprietary scripting software/modules/components etc. may be used to process the retrieved data. The retrieved data may be analyzed in order to determine the actions to be taken by the scripting language, including executing any method steps disclosed herein.

Server 110 and/or client 120 may run one or more software modules and/or components used in the context of the current invention, which may be stored in the memory of—and run on—the at least one server 110 and/or client 120. As non-limiting examples of such software, the paragraphs below describe in detail the software modules/components that make up the software combination. These software modules/components may comprise software and/or scripts containing instructions that, when executed by a microprocessor on a server 110 or client 120, cause the microprocessor to accomplish the purpose of the module/component as described in detail herein. The software combination may also share information, including data from data sources and/or variables used in various algorithms executed on the servers 110 and/or clients 120 within the system, between each module/component of the software combination as needed.

FIG. 4A shows a more detailed example embodiment of an environment for the systems, and for accomplishing the method steps, disclosed herein. As non-limiting examples, all disclosed software modules may run on one or more server(s) 110 and may include one or more user interfaces generated by the server(s) 110 and transmitted to and displayed on the client(s) 120. The user interface(s) may be configured to receive input from the user and transmit this input to the server(s) 110 for the administration and execution of the software 200, using data in data storage 130 associated with the software modules 200. Thus, the disclosed system may be configured to execute any or all of the method steps disclosed herein.

As noted above, in some embodiments, the disclosed system may store approved tag data in association with the unique long-range or short-range identification tag 105 that specifically associate the tag 105 with the disclosed system. Thus, to simplify the task of identifying a specific asset (e.g., a network or power cable), the disclosed embodiments provide administrators the ability to attach or otherwise associate a short range identification tag and/or a long range identification tag with each of the assets, such as attaching a tag to each of a particular server, cable, and/or bundle of cables (as seen in FIG. 4B) as a non-limiting example.

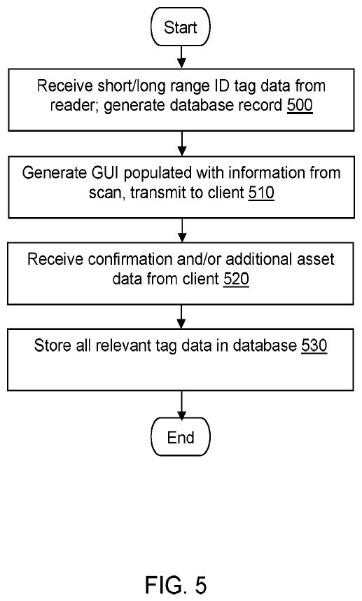

Using the present system one or more identification tags, each having embedded tag identifiers may be associated with particular assets. A description of those assets may be stored in associated with one or more identification tags. To illustrate, FIG. 5 depicts a flowchart showing a method wherein a server 110 may store a data record storing a unique identifier associated with a scanned tag 105 and may further generate a GUI for user to enter additional data related to a scanned tag 105 or its associated asset. The server 110 may then update the data record to include the received additional data. In Step 500, a user (e.g., a data center administrator) may attach a tag 105 (possibly using a self-laminating label or marker with an embedded identification tag 105, as described above) to each of one or more specific assets. Once the appropriate tag 105 is attached to the appropriate asset, the users of the disclosed system may then use the appropriate identification tag reader 300 hardware and settings to scan each tag to retrieve the embedded data (e.g., a unique identifier for the tag) stored within the memory of the tag 105, and transmit the scanned data through a network 100 to a computing device, such as a server 110 and/or client device 120. In some embodiments, the user may push the scan button 340 on the reader 300, to activate the long-range or short-range antenna 330 and associated circuitry for the scan.

Continuing with Step 500, the computing device 110, 120, may receive the scanned data, and generate a database record storing the scanned data. In some embodiments, the unique identifier for the tag 105 and/or asset may be used as a unique identifier for the database record. In embodiments where the reader 300 includes an embedded software 310 and/or database 320, the scanned data from the tag 105 may be processed by the software 310 and stored in the embedded database 320 as an interim step, not shown in FIG. 5. The data may then be selected from the embedded database 320 and transmitted through the network 100 to the computing device 110, 120, which may receive the scanned data, process it, generate the database record associated with the tag identified using the unique identifier, and store it in the system database 130.

In some embodiments, antenna 330 and its associated circuitry on the reader 300 may simply read the data stored on the tag 105, possibly in response to the scan button 340 being pressed, and stream the data through the network 100 to the computing device 110, 120, which may receive the scanned data, process it, generate the database record associated with the tag 105 (possibly both identified using the unique identifier), and store the tag data in the system database 130.

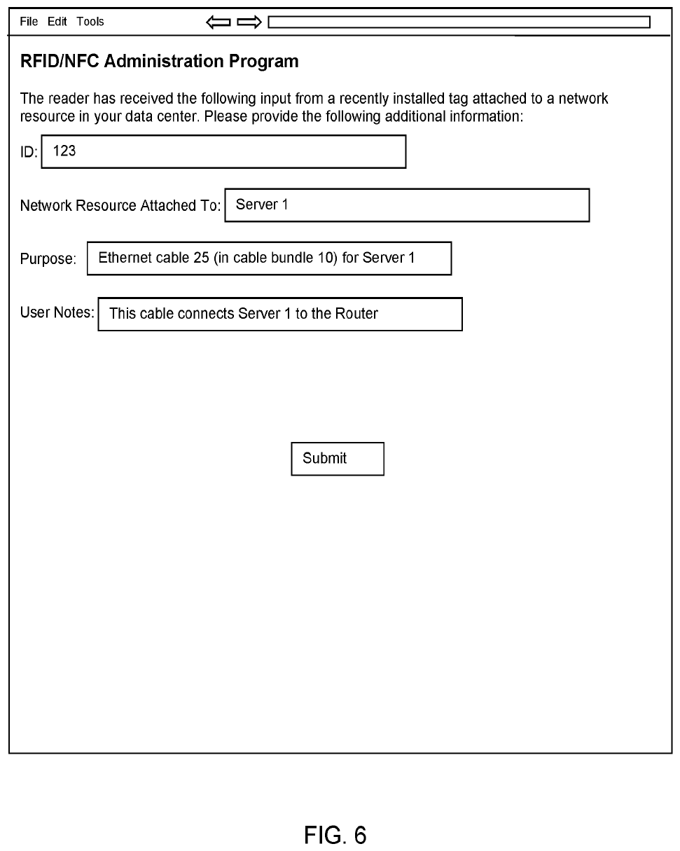

Returning to FIG. 5, in step 510, the computing device 110, 120 may then generate a GUI with one or more GUI components allowing a user to input additional details about the tag 105 or the asset to which the tag 105 is attached or near, such as a name, an associated resource, a name for the tagged resource, the purpose of the tag and/or the tagged resource, user comments about the tag, etc. In embodiments including multiple computing devices, a server device 110 may transmit the GUI or a portion of the GUI through the network 100 to a client device 120 for display. In embodiments that use an antenna 330 utilizing long range identification tag protocols, the GUI may include a GUI component (e.g., a checkbox, not seen in FIG. 6) specifying that the asset is best identified using a particular identification tag protocol (e.g., RFID) to locate the asset.

Returning to FIG. 5, in Step 520, the computing device 110, 120 may receive, from the generated and displayed GUI, user input including a confirmation of the previously generated and populated data, and additional input by the user in association with the tag data. In embodiments including multiple computing devices, the client device 120 may then transmit the received user input data to the server device 110. In Steps 520 and 530, the computing device 110, 120 may then receive the input data, and store the updated data in the appropriate data record. In embodiments that use an antenna 330 utilizing long range identification tag protocols and in which the appropriate GUI component is selected (e.g., a checkbox checked, indicating use of RFID technology), the data record may be updated to include a flag that the reader 300 should scan using a particular long range identification tag protocols.

As a non-limiting example demonstrated by FIGS. 5 and 6, a data center worker may tag a server, or a bundle of cables associated with a server, with a long-range identification tag 105. This identification tag 105 may identify a server or router to which several cables are attached, or perhaps a bundle of grouped cables, as demonstrated in FIG. 4B.

As each tag 105 is coupled to the server or cable bundle, the data center worker may use a reader 300 to scan the attached tag 105, possibly by pushing the scan button 340 to activate the antenna 330, and possibly to capture a unique identifier for the tag 105. In this example, the data center worker may then access a software running on a client device 120, including a GUI such as the one demonstrated in FIG. 6 (possibly generated by server 110 after generating a data record for the scanned tag 105), to confirm that the unique identifier is correct and/or to update the data record with additional data, possibly including a network resource to which the tag 105 is attached (e.g., “Server 1”), a purpose for the network resource (″Ethernet cable 25 (in cable bundle 10) for Server 1″), and additional user notes (“This cable connects Server 1 to the Router”), as non-limiting examples. Once the data center worker submits this data, the computing device 110, 120 may update the data record to reflect the newly received data.

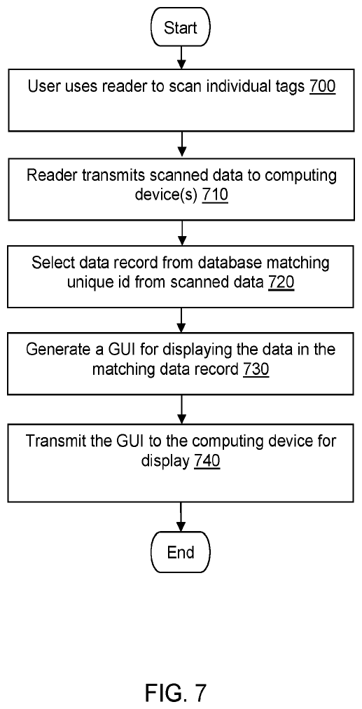

FIG. 7 demonstrates a non-limiting example embodiment wherein a server 110 receives data scanned from a tag 105, selects a data record from a database 130 according to a unique identifier for the tag 105, and generates a GUI to display the selected data to a user. In step 700, users may use the reader 300 to scan any of the individual tags 105 coupled to individual assets, possibly by pushing the scan button 340 and activating the antenna 330. The reader 300 may then receive the tag data from each tag 105 as it is scanned. In embodiments where the reader 300 includes an embedded software 310 and/or database 320, the reader may temporarily upload the database records into the embedded database 320. In embodiments where the reader 300 includes an embedded software 310 and database 320, the embedded software 310 may receive and process the scanned tag data from each tag 105, and execute a database command selecting a data record from the embedded database 320 that has a common unique identifier, or other stored tag data. In Step 710, the embedded software 310, or other instructions on the reader 300 may then transmit the data from the matching data record to the computing device 110, 120 for processing.

In embodiments where the reader 300 streams the scanned tag data through the network 100 to the computing device 110, 120, in Step 720, the computing device 110, 120 may receive and process the scanned tag data from each tag 105, and execute a database query selecting a data record from the database 130 that has a common unique identifier, or related data.

In Step 730, the computing device 110, 120 may then generate a GUI for displaying the data stored in the matching data record, and display this GUI to the user. In embodiments including multiple computing devices, a server device 110 may generate the GUI, and transmit the GUI through the network 100 to a client device 120 for display.

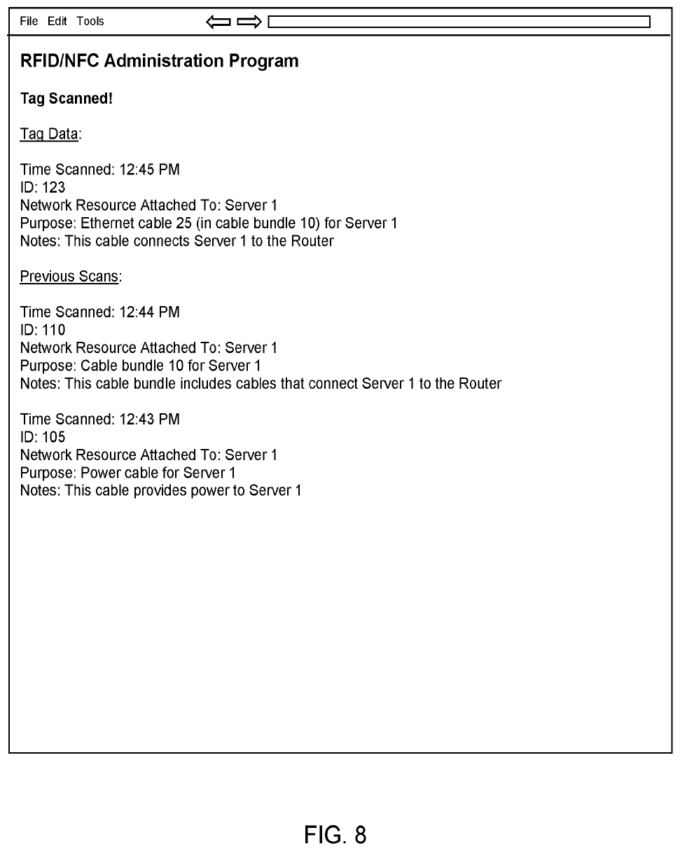

Continuing the example above, as seen in FIG. 8, the data center worker may scan each of the tags 105 associated with various assets in the data center, and as each tag 105 is scanned, the data center worker's client device may display the details within the data record for the tag 105 which has been scanned.

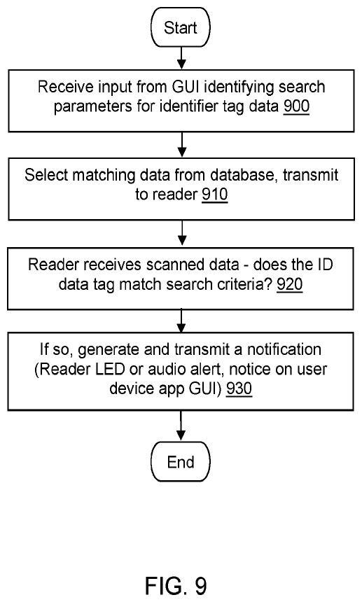

FIG. 9 demonstrates a non-limiting example embodiment wherein a user desires to find a specific cable or other specific asset. The server generates a GUI receiving search criteria from the user. Then, as the user scans various assets, the scanned data is returned to the server 110 or an onboard software 310 on the reader 300. The scanned data is compared with the search criteria, and if a match is found, a notification is transmitted to the user.

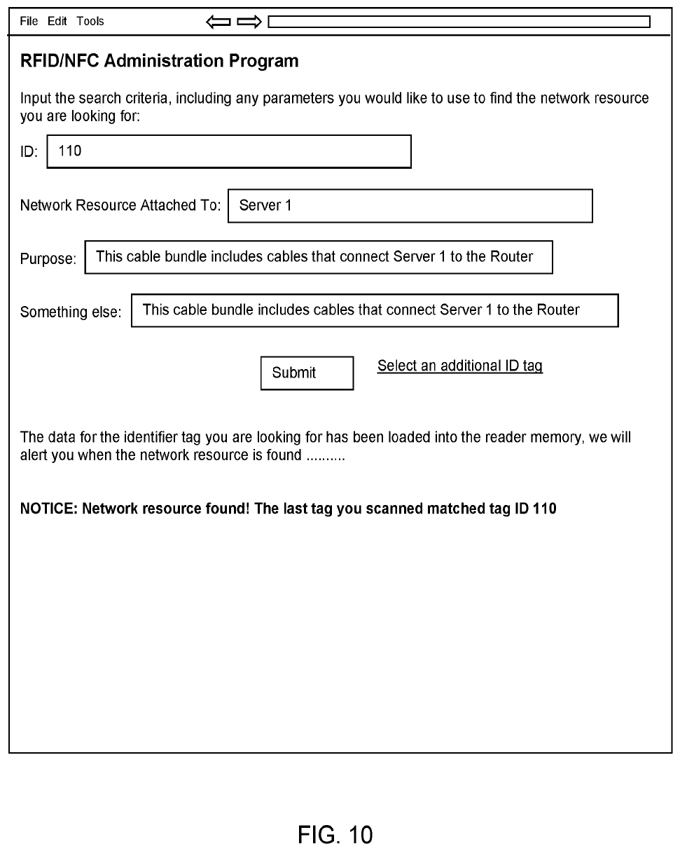

In some embodiments, a user may want to search for an asset associated with a specific identification tag 105. For example, a data center software may indicate to a data center worker that a particular network cable is malfunctioning and needs to be replaced. In these embodiments, the user may access the system and indicate a desire to locate one or more assets associated with one or more specific identification tags 105. In response to this request, as seen in Step 900 of FIG. 9, and FIG. 10, the computing device 110, 120 may generate a GUI receiving input from the user defining the search criteria, including one or more parameters, for finding the assets and their associated identification tags 105.

For example, as seen in the non-limiting example in FIG. 10, for each identification tag 105 the user wants to locate, the GUI may include one or more GUI components for receiving user input from the user, including the identification tag's unique identifier, the network resource or other asset associated with the identification tag 105, the purpose of the asset and/or network resource, the purpose of the asset/resource, any notes associated with the asset/resource, or any additional data stored in the database 130 and associated with the asset.

In embodiments including multiple computing devices 110, 120, a server device 110 may generate the GUI, and transmit the GUI through the network 100 to a client device 120 for display, and the client device 120 may receive the user input and transmit it through the network 100 to the server device 110 for processing.

Returning to FIG. 9, in step 910, the computing device 110, 120 may receive the user input from the GUI, and execute a database command selecting any data records that match the input search criteria from the database 130. In embodiments that use an antenna 330 or its associated circuitry to apply a long range identification tag protocol (e.g., RFID) to identify an associated asset (e.g., the server or network cable bundle associated with the cable they are trying to find in FIG. 10), the database record may include a flag indicating that the long range identification tag protocol should be used first to locate the first asset (e.g., the network cable bundle in FIG. 10 or the associated server, Server 1), and then activate a controller configured to switch from the first antenna to a second antenna 330 and its associated circuitry to apply the short range identification tag protocol (e.g., NFC) to locate the specific cable (e.g., Ethernet cable 25 from FIG. 8, within cable bundle 10, which connects Server 1 to the Router).

In embodiments where the reader 300 includes an embedded software 310 and/or database 320, the computing device 110, 120 may transmit the selected data from the database 130 (the selected identification tags 105 and their associated assets) through the network 100 to the reader 300 for processing by the embedded software 310 and storage in the embedded database 320. In embodiments where the reader 300 streams the scanned tag data through the network 100 to the computing device 110, 120, the computing device 110, 120 may temporarily store the selected data from the database 130 on the computing device 110, 120.

The user may then use each of the antennas, using the appropriate identification tag protocol, to scan each of multiple identification tags 105 to locate the requested asset by its associated tag 105, or by any other identified search criteria, possibly by pushing scan button 340 to activate antenna 330. In embodiments that use a long range identification tag protocols to identify an associated asset (e.g., the server or network cable bundle associated with the cable they are trying to find in FIG. 10), the selected data may include the database flag indicating that the reader 300 should use the first antenna to scan using a long range identification tag protocol, such as RFID. In embodiments where the reader 300 includes an embedded software 310 and database 320, the computing device 110, 120 may transmit the flag through the network to the reader 300, which may process the flag and automatically use the first antenna to apply the long-range identification tag protocol to scan the identification tags 105. In embodiments where the reader 300 streams the scanned tag data through the network 100 to the computing device 110, 120, the computing device 110, 120 may use the data flag to indicate that the reader 300 should be utilizing the long range identification tag protocol to scan the tags 105.

Returning to FIG. 9, in Step 920, as the user scans for the requested identification tag 105, the reader 300 may receive the data from each of the scanned identification tags 105, and compare the received data with the data stored in the embedded database 320 using the embedded software 310, or transmitted through the network 100 to the computing device 110, 120 and compared with the temporarily stored selected data.

As noted above, the reader 300 may include components 360 integrated into the reader 300 providing for audio and visual notifications (e.g., audio alerts or LED signals), possibly configured by a user, so that when the scanned and received identification tag data matches a unique identifier or other search criteria from the selected data record(s) stored in the embedded database 320 (for embodiments that include an embedded software and/or database), or a unique identifier or other search criteria temporarily stored on the computing device 110, 120 (for embodiments where the reader streams the scanned tag data through the network to the computing device) the device triggers an output of the notification, including illumination of a custom color LED, and/or a custom audio alert 360. The user may then identify the long-range identification tag 105 associated with the asset (e.g., the server or network cable bundle to which the desired cable belongs).

In some embodiments, the identified match may be received by the computing device 110, 120, either from software logic on the computing device, or through the network 100 from the embedded software 310 on the reader 300. In response to receiving the identified match, the computing device 110, 120 may generate a GUI, or a command to update a currently displayed GUI, including a GUI component displaying a notification indicating that the most recently scanned identification tag 105 and/or asset matches one of the unique identifiers or other search criteria selected from the database records. This notification may then be displayed on the GUI on the computing device 110, 120.

In embodiments that use a long range identification tag to identify an associated asset, the embedded software 310 may include a controller and associated logic to automatically switch from a first antenna 330 and its associated circuitry wirelessly receiving the identification tag data using a long range identification tag protocol (e.g., RFID), to a second antenna 330 and its associated circuitry wirelessly receiving the identification tag data using a short range identification tag protocol (e.g., NFC), for embodiments that include an embedded software 310 and/or database 320. For embodiments where the reader 300 streams the scanned tag data through the network 100 to the computing device, the computing device 110, 120, subsequent to transmitting a signal triggering the custom alert on the reader 300, may include logic to switch from the antenna using a long range identifier protocol to an antenna using a short range identification tag protocol.

Once the reader 300 is operating using the short range identification tag protocol, or in embodiments that that use a short range identification tag to identify an associated asset (e.g., the individual cable associated with the server or network cable bundle that they are trying to find), The user may then scan for the requested identification tag 105 and its associated asset (e.g., a specific cable within a cable bundle, and/or attached to an associated asset such as a server).

In embodiments where the reader 300 includes an embedded software 310 and database 320, if there is no flag indicating the use of long range identification tag protocol, or if the reader has switched from a long range to a short range identification tag protocol subsequent to finding a matching identification tag 105 using long range identification tag protocol, the computing device 110, 120 may automatically configure the reader 300 to use the short range identification tag protocol to scan the identification tags 105.

In embodiments where the reader 300 streams the scanned tag data through the network 100 to the computing device, the computing device 110, 120 may fail to identify a flag indicating the use of long range identification tag protocol, or data logic that now indicates that the reader 300 should now be utilizing the short range identification tag protocol to scan the tags 105.

As before, analogous to FIGS. 9 and 10, as the user scans for the requested identification tag 105 (Step 920), the reader 300 may receive the data from each of the identification tags 105, and compare the received data with the data stored in the embedded database 320 using the embedded software 310, or transmitted through the network 100 to the computing device 110, 120 and compared with the temporarily stored selected data.

Then, analogous to step 930 described above, the reader 300 may include components 360 integrated into the reader 300 providing for audio and visual notifications (e.g., audio alerts or LED signals), possibly configured by a user, so that when the scanned and received identification tag data matches a unique identifier stored in the embedded database 320 (for embodiments that include an embedded software and/or database), or a unique identifier temporarily stored on the computing device 110, 120 (for embodiments where the reader streams the scanned tag data through the network to the computing device), the device triggers illumination of a custom color LED, and/or a custom audio alert 360. The user may then identify the long-range identification tag 105 associated with the asset (e.g., the server or network cable bundle to which the desired cable belongs).

In some embodiments, the identified match may be received by the computing device 110, 120, either from software logic on the computing device, or through the network 100 from the embedded software 310 on the reader. In response to receiving the identified match, the computing device 110, 120 may generate a GUI, or a command to update a currently displayed GUI, including a GUI component displaying a notification indicating that the most recently scanned identification tag 105 and/or asset matches one of the unique identifiers selected from the database records. This notification may then be displayed on the GUI on the computing device 110, 120.

The steps included in the embodiments illustrated and described in relation to FIGS. 1-10 are not limited to the embodiment shown and may be combined in several different orders and modified within multiple other embodiments. Although disclosed in specific combinations within these figures, the steps disclosed may be independent, arranged and combined in any order and/or dependent on any other steps or combinations of steps.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system, comprising:
an identification tag coupled to a label, the label being configured to attach to an asset;
an identification tag reader configured to wirelessly read an identification tag data received in a wireless transmission from the identification tag; and
a computing device coupled to a network and including at least one processor executing instructions within a memory which, when executed, cause the system to:
receive, from the identification tag reader, the identification tag data, including a unique identifier for the identification tag;
encode, in a database record, the identification tag data;
output, using a display screen of the computing device, a graphical user interface (GUI) including at least one GUI user interface component;
receive, using the GUI user interface component, an additional data associated with the asset; and
modify the database record to include the additional data, wherein the additional data is associated with the identification tag data.

2. The system of claim 1, wherein the identification tag reader further comprises at least one antenna configured to receive the wireless transmission broadcast by the identification tag in response to an interrogation signal transmitted by the identification tag reader.

3. The system of claim 2, wherein the at least one antenna further comprises a first antenna circuit configured to wirelessly receive the identification tag data using a Near Field Communication protocol.

4. The system of claim 2, wherein the at least one antenna further comprises a second antenna circuit configured to wirelessly receive the identification tag data using a Radio Frequency Identification protocol.

5. A system, comprising:
an identification tag coupled to a label, the label being configured to attach to an asset;
an identification tag reader configured to wirelessly read an identification tag data received in a wireless transmission from the identification tag; and
a computing device coupled to a network and including at least one processor executing instructions within a memory which, when executed, cause the system to:
receive, from the identification tag reader, the identification tag data, including a unique identifier for the identification tag;
execute a database command selecting a database record including the unique identifier and an additional data associated with the asset;
output, using a display screen of the computing device, a graphical user interface (GUI) comprising a GUI user interface component displaying the identification tag data and the additional data; and
display the GUI on the computing device.

6. The system of claim 5, wherein the identification tag reader further comprises at least one antenna configured to receive the wireless transmission broadcast by the identification tag in response to an interrogation signal transmitted by the identification tag reader.

7. The system of claim 6, wherein the at least one antenna further comprises a first antenna circuit configured to wirelessly receive the identification tag data using a Near Field Communication protocol.

8. The system of claim 6, wherein the at least one antenna further comprises a second antenna circuit configured to wirelessly receive the identification tag data using a Radio Frequency Identification protocol.

9. A system, comprising:
an identification tag coupled to a label, the label being configured to attach to an asset;
an identification tag reader configured to wirelessly read an identification tag data received in a wireless transmission from the identification tag; and
a computing device coupled to a network and including at least one processor executing instructions within a memory which, when executed, cause the system to:
output, using a display screen of the computing device, a graphical user interface (GUI) comprising at least one GUI user interface component receiving, using the GUI user interface component, a search criteria used to locate the identification tag;
receive the search criteria;
receive, from the identification tag reader, an identification tag data;
determine whether the identification tag data matches the search criteria;
responsive to a determination that the identification tag data matches the search criteria, generate a notification; and
output the notification on at least one of the identification tag reader and the GUI.

10. The system of claim 9, wherein the identification tag reader further comprises a first antenna including a long-range antenna circuit configured to wirelessly receive the identification tag data using a Radio Frequency Communication protocol.

11. The system of claim 10, further comprising a second identification tag coupled to a second label, the second label being configured to attach to a second asset and wherein the identification tag reader further comprises:
a second antenna comprising a short-range antenna circuit configured to wirelessly receive a second identification tag data from the second identification tag using a Near Field Communication protocol.

12. The system of claim 11, wherein the identification tag reader further comprises a controller configured to switch from receiving the identification tag data using the first antenna to receiving the identification tag data using the second antenna responsive to the determination that the at least one identification tag data matches the search criteria.

13. The system of claim 10, wherein the identification tag reader further comprises a user interface device including a light emitting diode or an audio output device and the computing device is configured to, after determining that the at least one identification tag data matches the search criteria, cause the identification tag reader to generate an output at the user interface device.
